(19) United States
(12) Patent Application Publication
(10) Pub. No.: US 2011/0234996 A1
(43) Pub. Date: Sep. 29, 2011

(54) DISCHARGE LAMP UNIT AND PROJECTION TYPE IMAGE DISPLAY APPARATUS USING THE SAME

(75) Inventor: Masaru IKEDA, Osaka (JP)

(73) Assignee: PANASONIC CORPORATION, Osaka (JP)

(21) Appl. No.: 13/037,323

(22) Filed: Feb. 28, 2011

(30) Foreign Application Priority Data
Mar. 26, 2010 (JP) 2010-071999

(51) Int. Cl. H05B 37/02; G03B 21/14

(52) U.S. Cl. 353/85; 315/291

(57) ABSTRACT

Provided is a discharge lamp unit operable to detect a precursor of breakage of a lamp before the lamp is broken and to prevent breakage of the lamp. The discharge lamp unit includes: a discharge lamp; a lighting device for supplying a current to the discharge lamp; and a detection circuit for controlling, by controlling the lighting device, supply of current to the discharge lamp when the detection circuit detects expansion of the discharge lamp. The detection circuit detects a precursor of breakage before expansion of the discharge lamp causes breakage and terminates supply of current to the discharge lamp.

### CROSS-REFERENCE TO RELATED APPLICATION

The disclosure of Japanese Patent Application No. 2010-071999, filed on Mar. 26, 2010, is incorporated herein by reference.

### BACKGROUND OF THE INVENTION

1. Field of the Invention

The present invention relates to a discharge lamp unit and a projection type image display apparatus using the discharge lamp unit.

2. Description of the Background Art

For example, a liquid crystal projector and a DLP projector are used for presentation of research work at a conference, presentation of merchandise, a home theater, and the like. The liquid crystal projector includes a light source device having a light source lamp for projection, an optical system, and a liquid crystal display panel. In the liquid crystal projector, light from the light source lamp enters the liquid crystal display panel via the optical system and is subjected to light modulation in the liquid crystal display panel, whereby an image displayed in the liquid crystal display panel is projected onto a screen in an enlarged manner. In general, as a light source, a high-pressure discharge lamp is used. Hereinafter, as one example of the high-pressure discharge lamp, a high-pressure mercury lamp will be described.

In the high-pressure mercury lamp, a pair of electrodes made of tungsten, mercury as a light-emitting material, a halogen substance such as bromine and iodine for ensuring a lamp life are sealed in a housing made of glass. In the high-pressure mercury lamp, when the lamp is lit up, a vapor pressure therein reaches a pressure of 200 atmospheres or more and the temperature of a lamp surface reaches 1000° C. In addition, there may be a case where the lamp is broken while a projector is being used, and sound of the breakage, pieces of the broken glass, necessity of cleaning of glass chippings, and the like may provide an uncomfortable feeling to a user.

There are two causes of the breakage of the lamp:

(Case 1) Due to a shortage and a deterioration of a mechanical strength of the glass of which the housing is made, the glass cannot withstand the pressure of 200 atmospheres or more, thereby causing the breakage.

(Case 2) The tungsten which is a material of the electrodes accumulates on a wall of a tube inside the lamp (the so-called blackening phenomenon) and absorbs infrared components of light emitted from the lamp itself, the temperature of the glass increases and reaches a softening point, and the glass expands, thereby causing the breakage.

In other words, the breakage in (Case 1) is due to expansion of the glass caused by pressure; and the breakage in (Case 2) is due to expansion of the glass caused by temperature.

On the other hand, in consideration of the breakage of the lamp, a method of reducing the uncomfortable feeling provided to a user and of enhancing safety is proposed (for example, Japanese Patent Application Laid-Open Publication No. 2001-209123 (hereinafter, referred to as patent document 1)). In the method in patent document 1, an electrically-conductive wire is laid in the vicinity of the lamp, and when the lamp is broken, the electrically-conductive wire is ruptured and the rupture is detected, whereby a fan in the vicinity of the lamp is shut off, blades of the shut-off fan block the pieces of the broken glass, and the pieces of the broken glass are thereby prevented from scattering out of the projector. However, the above-mentioned method is an emergency countermeasure taken after the lamp has been broken, and there remain problems in that when the lamp is broken, a user is still faced with the uncomfortable feeling caused by the sound of the breakage and the fine pieces of the broken glass inside the projector still need to be cleaned-up.

### SUMMARY OF THE INVENTION

Therefore, objects of the present invention are to provide: a discharge lamp unit which is operable to detect a precursor of breakage of a lamp before the lamp is broken and to prevent breakage of the lamp; and a projection type image display apparatus using this discharge lamp unit.

To achieve the above-mentioned objects, the discharge lamp unit according to the present invention comprises: a discharge lamp; a lighting device for supplying a current to the discharge lamp; and a detection circuit for controlling, by controlling the lighting device, supply of current to the discharge lamp when the detection circuit detects expansion of the discharge lamp.

Specifically, the detection circuit detects a precursor of breakage of the discharge lamp before expansion of the discharge lamp causes breakage, controls the lighting device, and decreases the current supplied to the discharge lamp. Furthermore, the detection circuit may detect a precursor of breakage of the discharge lamp before expansion of the discharge lamp causes breakage, control the lighting device, and terminate supply of current to the discharge lamp.

In addition, on a surface of the discharge lamp, an electrically conductive thin film is formed. The detection circuit monitors at least one of the direct current resistance value of the electrically conductive thin film, the alternating current impedance value of the electrically conductive thin film, or the temperature of the electrically conductive thin film, and thereby detects the expansion of the discharge lamp. For example, when the direct current resistance value of the electrically conductive thin film reaches a first threshold value, the detection circuit controls the lighting device and decreases the current supplied to the discharge lamp. Furthermore, when the direct current resistance value of the electrically conductive thin film reaches a second threshold value, the detection circuit may control the lighting device and terminates supply of current to the discharge lamp.

In addition, when the alternating current impedance value of the electrically conductive thin film reaches a first threshold value, the detection circuit controls the lighting device and decreases the current supplied to the discharge lamp. Furthermore, when the alternating current impedance value of the electrically conductive thin film reaches a second threshold value, the detection circuit may control the lighting device and terminate supply of current to the discharge lamp.

In addition, when the temperature of the electrically conductive thin film reaches a first threshold value, the detection circuit controls the lighting device and decreases the current supplied to the discharge lamp. Furthermore, when the temperature of the electrically conductive thin film reaches a second threshold value, the detection circuit may control the lighting device and terminate supply of current to the discharge lamp.

In addition, on a front side and a back side of the discharge lamp, electrically conductive thin films may be formed and the detection circuit may monitor the capacitance value of the material of the discharge lamp, sandwiched between the electrically conductive thin films, and thereby detect the expansion of the discharge lamp.

The discharge lamp unit according to the present invention is operable to prevent breakage of a lamp by controlling supply of current to the lamp before the lamp is broken when a precursor of breakage of the lamp is detected. Thus, the uncomfortable feeling a user experiences by the breakage of the lamp while a projector or the like is being used can be avoided and enhancement of safety is enabled.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating a configuration of a high-pressure mercury lamp;

FIG. 2 is a partial cutaway perspective view showing a configuration of a lamp unit (high-pressure discharge lamp apparatus) using a high-pressure mercury lamp;

FIG. 3 is a diagram illustrating a configuration of an electronic ballast;

FIG. 4A is a table showing a relationship between the degree of expansion of glass and the resistance value of a nichrome thin film;

FIG. 4B is a table showing a relationship between the degree of expansion of the glass and the capacitance value of a glass part 211;

FIG. 4C is a flowchart showing one example of an operation of a discharge lamp unit;

FIG. 5 is a diagram illustrating a configuration of a lamp unit (high-pressure discharge lamp apparatus) using a high-pressure mercury lamp; and

FIG. 6 is a block diagram illustrating a configuration of a liquid crystal projector.

### DESCRIPTION OF THE PREFERRED EMBODIMENTS

### Embodiment 1

(1) High-Pressure Discharge Lamp

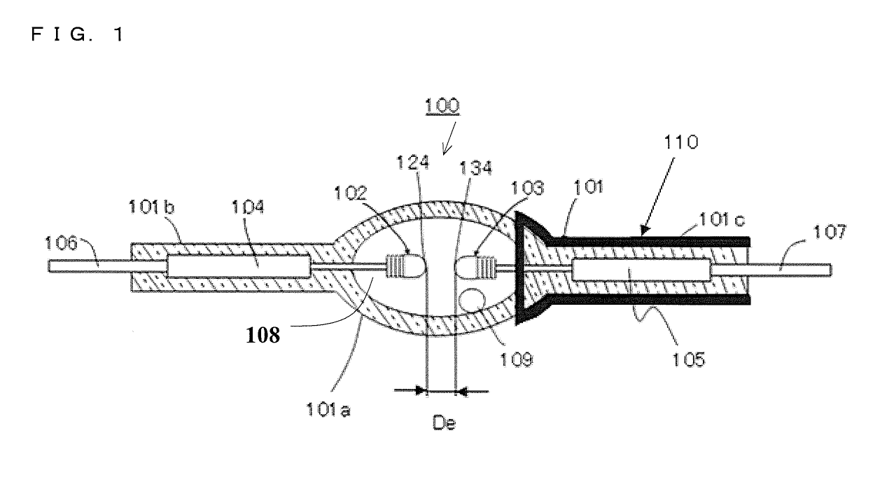

FIG. 1 is a diagram illustrating a configuration of a high-pressure mercury lamp 100 having a rated power of 300 W as one example of a high-pressure discharge lamp. Hereinafter, the high-pressure discharge lamp is simply referred to as a “lamp”. In FIG. 1, a cross-sectional view of the lamp 100, which is taken at a part where electrodes are exposed, is shown for convenience' sake. As shown in FIG. 1, the lamp 100 includes: a light-emitting part 101a which is of a spheroidal shape; and an arc tube 101 made of quartz, which has sealing parts 101b and 101c formed on both end portions of the light-emitting part 101a. Mercury 109 as a light-emitting material, a noble gas such as argon, krypton, and xenon for a starting aid, and a halogen substance such as iodine and bromine are sealed in a light-emitting space 108 inside the light-emitting part 101a. In this case, an amount of the sealed mercury 109 is set to be greater than or equal to 250 mg/cm³ per internal volume of the arc tube 101 and a sealing pressure of the noble gas, applied when the lamp is cool, is set to be in a range of 0.01 MPa to 1 MPa.

In addition, inside the light-emitting part 101, a pair of electrodes 102 and 103 made of tungsten (W) are arranged so as to substantially face each other. An interval between end portions 124 and 134 of these electrodes 102 and 103, that is, a distance De between the electrodes is set to be in a range of 0.5 mm to 2.0 mm. The electrodes 102 and 103 are electrically connected to molybdenum foil 104 and 105 sealed in the sealing parts 101b and 101c.

The molybdenum foil 104 and 105 are connected to external leads 106 and 107 which are led outside from edge surfaces of the sealing parts 101b and 101c to an outside of the arc tube 101. As the halogen substance, the bromine whose amount is within a range of 1×10⁻¹⁰ to 1×10⁻⁴ mol/cm³ is used. Due to the so-called halogen cycle, the bromine returns the tungsten vaporized from the electrodes 102 and 103 to the electrodes, and accumulation of a material of the electrodes on an inner surface of the light-emitting part 101a is thereby suppressed. In order to cause the halogen cycle to function most effectively, in particular, it is preferable that an amount of the sealed bromine is within a range of 1×10⁻⁹ to 1×10⁻⁵ mol/cm³ or less.

On the lamp 100, an electrically conductive thin film 110 is formed. In this example, as a material of the thin film, nichrome is used. In addition, the thin film is formed by employing a method of vacuum deposition or sputtering so as to have a thickness in a range of 100 μm to 500 μm.

(2) Lamp Unit

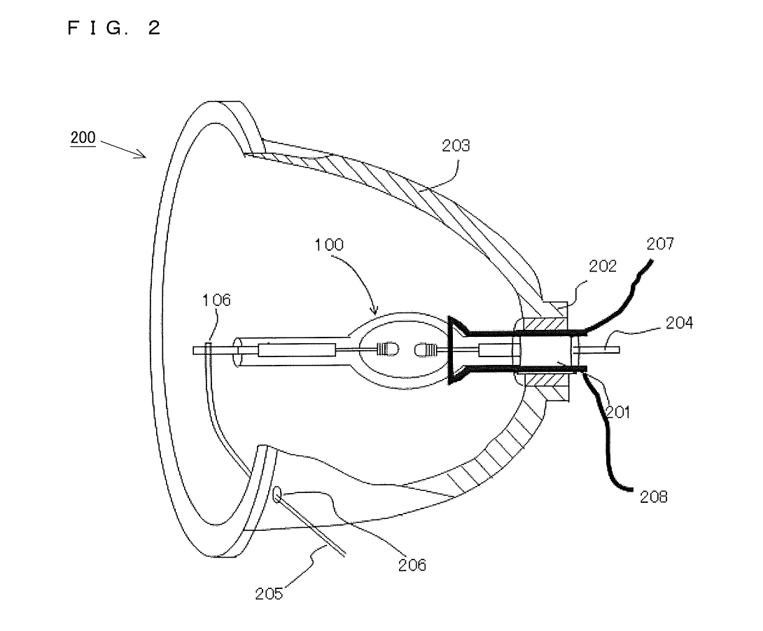

FIG. 2 is a partial cutaway perspective view showing a configuration of a lamp unit 200 into which the above-described lamp 100 is incorporated. As shown in FIG. 2, in the lamp unit 200, a base 201 is attached on one of tube end portions of the arc tube 101 of the lamp 100. By means of a terminal 204 which is led to the outside via a spacer 202 and lead wires 205 which are led to the outside so as to pass through a through-hole 206 provided in a reflecting mirror 203, a current is supplied to the lamp unit 200. In addition, lead wires 207 and 208 for connecting the electrically conductive thin film 110 and a lighting device are led out.

(3) Lighting Device (Electronic Ballast)

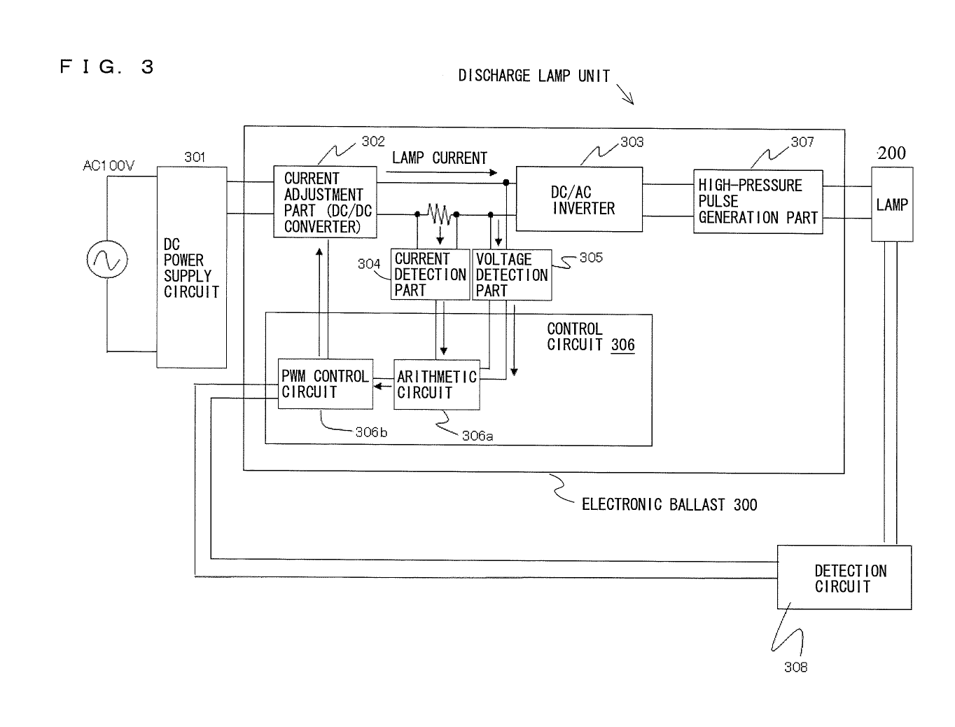

FIG. 3 is a diagram illustrating a configuration of a lighting device 300 which lights up the lamp 100. The lighting device (hereinafter, referred to as an electronic ballast) 300 supplies a current to the lamp unit 200. As shown in FIG. 3, the electronic ballast 300 is connected to the lamp unit 200 into which the lamp 100 is incorporated, a DC power supply circuit 301, and a detection circuit 308. Here, a unit having a configuration in which the lamp unit 200, the detection circuit 308, and the electronic ballast 300 are combined can also be referred to as a discharge lamp unit.

The electronic ballast 300 has a current adjustment part (DC/DC converter) 302, a DC/AC inverter 303, a tube current detection part 304, a tube voltage detection part 305, a control circuit 306, and a high-pressure pulse generation part 307. In FIG. 3, an example in which the DC power supply circuit 301 is externally connected to the electronic ballast 300 is shown. However, besides the above-mentioned configuration, the electronic ballast 300 may have the DC power supply circuit 301 internally provided.

The DC power supply circuit 301 includes, for example, a rectifier circuit, and generates a direct-current voltage from a household alternating current of 100V and supplies the direct-current voltage to the electronic ballast 300. In the electronic ballast 300, a direct-current voltage is supplied to the current adjustment part (DC/DC converter) 302 from the DC power supply circuit 301. The current adjustment part (DC/DC converter) 302 supplies a predetermined magnitude of a direct current (lamp current) to the DC/AC inverter 303. Based on a control signal sent out from the control circuit 306, the DC/AC inverter 303 generates a rectangular wave alternating current having a predetermined frequency and supplies the rectangular wave alternating current to the high-pressure pulse generation part 307. The high-pressure pulse generation part 307 includes, for example, a transformer, and generates a high voltage and applies the high voltage to the lamp unit 200.

The tube current detection part 304 and the tube voltage detection part 305 are connected between the current adjustment part (DC/DC converter) 302 and the DC/AC inverter 303. The tube current detection part 304 detects the lamp current supplied from the current adjustment part (DC/DC converter) 302 to the DC/AC inverter 303. The tube voltage detection part 305 detects a voltage (lamp voltage) between the current adjustment part (DC/DC converter) 302 and the DC/AC inverter 303.

The control circuit 306 controls the current adjustment part (DC/DC converter) 302, the DC/AC inverter 303, and the like in a centralized manner. The control circuit 306 has an arithmetic circuit 306a and a PWM control circuit 306b. Based on the lamp current and the lamp voltage detected respectively by the tube current detection part 304 and the tube voltage detection part 305, the arithmetic circuit 306a calculates a lamp electric power. Based on a result of the calculation in the arithmetic circuit 306a, the PWM control circuit 306b controls the current adjustment part (DC/DC converter) 302 and the DC/AC inverter 303.

The detection circuit 308 monitors the resistance value of the electrically conductive thin film 110 formed on the lamp 100 and thereby detects expansion of the lamp 100. The detection circuit 308 has stored therein data, obtained by experiment, indicating a relationship between the degree of thermal expansion of the glass and the resistance value of the electrically conductive thin film 110. In other words, the detection circuit 308 has stored therein the resistance value (threshold value) of the electrically conductive thin film 110, which is obtained before the glass expands and the lamp 100 is broken. When the value of resistance of the electrically conductive thin film 110 formed on the lamp 100 reaches the threshold value, the detection circuit 308 sends out a signal to the control circuit 306 and stops the operation of the electronic ballast 300 (that is, terminates supply of current to the lamp 100).

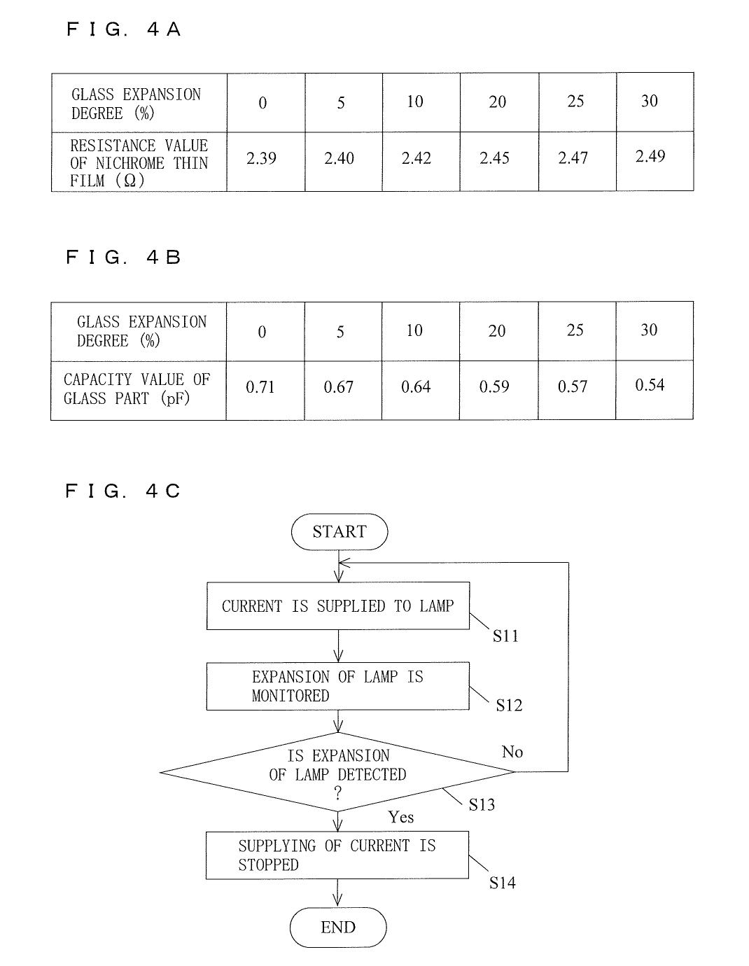

FIG. 4A is a table showing a relationship between the degree of expansion of the glass of the lamp 100 and the resistance value of the nichrome thin film (electrically conductive thin film 110), which was obtained by experimental investigation. In the example shown in FIG. 4A, the experimental investigation made clear that when the degree of expansion of the glass reached 25%, the lamp 100 was broken. Therefore, when the resistance value of the nichrome thin film reaches 2.47Ω, the operation of the electronic ballast 300 is stopped.

Here, an operation of the discharge lamp unit, which, when performed, causes the operation of the electronic ballast 300 to stop, will be described with reference to FIG. 4C. FIG. 4C is a flowchart showing one example of the operation of the discharge lamp unit. With reference to FIG. 4C, the electronic ballast 300 supplies a current to the lamp unit 200 (that is, the lamp 100) and lights up the lamp 100 (step S11). Next, while the lamp 100 is lit up, the detection circuit 308 measures the resistance value of the electrically conductive thin film 110 and thereby monitors the expansion of the lamp 100 (step S12). When the detection circuit 308 detects expansion of the lamp 100 (Yes at step S13), the detection circuit 308 controls the electronic ballast 300 and terminates supply of current to the lamp unit 200 (step S14). When the detection circuit 308 does not detect the expansion of the lamp 100 (No at step S13), supply of current to the lamp unit 200 is not terminated.

When the resistance value of the electrically conductive thin film 110 formed on the lamp 100 reaches the threshold value, the detection circuit 308 may send out a signal to the control circuit 306 and decrease the current supplied from the electronic ballast 300 to the lamp unit 200. For example, when the resistance value of the nichrome thin film (electrically conductive thin film 110) reaches 2.45Ω, the detection circuit 308 reduces the current supplied to the electronic ballast 300 by half. It is only required that as a degree of decreasing the current supplied to the lamp unit 200, an optimum value previously calculated is set.

In addition, the detection circuit 308 may have stored therein a plurality of threshold values, and based on a relationship between the resistance value of the electrically conductive thin film 110 and the plurality of threshold values, the detection circuit 308 may control the electronic ballast 300 and thereby control supply of current to the lamp unit 200. For example, the detection circuit 308 has stored therein a first value of resistance (first threshold value) and a second value of resistance (second threshold value). When the resistance value of the electrically conductive thin film 110 formed on the lamp 100 reaches the first threshold value, the detection circuit 308 sends out a signal to the control circuit 306 and decreases the current supplied to the lamp unit 200 from the electronic ballast 300. In addition, when the resistance value of the electrically conductive thin film 110 formed on the lamp 100 reaches the second threshold value, the detection circuit 308 stops the operation of the electronic ballast 300.

Furthermore, in the present embodiment, the detection circuit 308 monitors the resistance value of the direct current of the electrically conductive thin film 110, thereby monitoring the expansion of the glass (lamp 100), and stops the electronic ballast 300 before the lamp 100 is broken. However, the detection circuit 308 may monitor the alternating current impedance value of the electrically conductive thin film 110, thereby monitoring the expansion of the glass, and stop the electronic ballast 300 before the lamp 100 is broken. In this case, the detection circuit 308 has stored therein the alternating current impedance value (threshold value) of the electrically conductive thin film 110, which is obtained before the glass expands and the lamp 100 is broken, and when the alternating current impedance value of the electrically conductive thin film 110 reaches the threshold value, the detection circuit 308 sends out a signal to the control circuit 306 and stops the operation of the electronic ballast 300 (that is, terminates supply of current to the lamp 100).

In addition, when the alternating current impedance value of the electrically conductive thin film 110 formed on the lamp 100 reaches the threshold value, the detection circuit 308 may send out a signal to the control circuit 306 and decrease the current supplied from the electronic ballast 300 to the lamp unit 200. Furthermore, the detection circuit 308 may have stored therein a plurality of threshold values, and based on a relationship between the alternating current impedance value of the electrically conductive thin film 110 and the plurality of threshold values, the detection circuit 308 may control the electronic ballast 300 and control supply of current to the lamp unit 200. For example, the detection circuit 308 has stored therein a first value of the alternating current impedance (first threshold value) and a second value of the alternating current impedance (second threshold value), and when the alternating current impedance value of the electrically conductive thin film 110 formed on the lamp 100 reaches the first threshold value, the detection circuit 308 sends out a signal to the control circuit 306 and decreases the current from the electronic ballast 300 to the lamp unit 200. In addition, when the alternating current impedance value of the electrically conductive thin film 110 formed on the lamp 100 reaches the second threshold value, the detection circuit 308 stops the operation of the electronic ballast 300.

In addition, the detection circuit 308 may monitor the temperature of the electrically conductive thin film 110, thereby monitoring the expansion of the glass, and stop the electronic ballast 300 before the lamp 100 is broken. In this case, the detection circuit 308 has stored therein the temperature (threshold value) of the electrically conductive thin film 110, which is obtained before the glass expands and the lamp 100 is broken, and when the temperature of the electrically conductive thin film 110 reaches the threshold value, the detection circuit 308 sends out a signal to the control circuit 306 and stops the operation of the electronic ballast 300 (that is, terminates supply of current to the lamp 100). Here, the detection circuit 308 may directly measure the temperature of the lamp 100, instead of monitoring the temperature of the electrically conductive thin film 110.

In addition, when the temperature of the electrically conductive thin film 110 formed on the lamp 100 reaches the threshold value, the detection circuit 308 may send out a signal to the control circuit 306 and decrease the current supplied from the electronic ballast 300 to the lamp unit 200. Furthermore, the detection circuit 308 may have stored therein a plurality of threshold values, and based on a relationship between the temperature of the electrically conductive thin film 110 and the plurality of threshold values, the detection circuit 308 may control the electronic ballast 300 and control the current supplied to the lamp unit 200. For example, the detection circuit 308 has stored therein a first temperature (first threshold value) and a second temperature (second threshold value), and when the temperature of the electrically conductive thin film 110 formed on the lamp 100 reaches the first threshold value, the detection circuit 308 sends out a signal to the control circuit 306 and decreases the current supplied from the electronic ballast 300 to the lamp unit 200. When the temperature of the electrically conductive thin film 110 formed on the lamp 100 reaches the second threshold value, the detection circuit 308 may stop the operation of the electronic ballast 300.

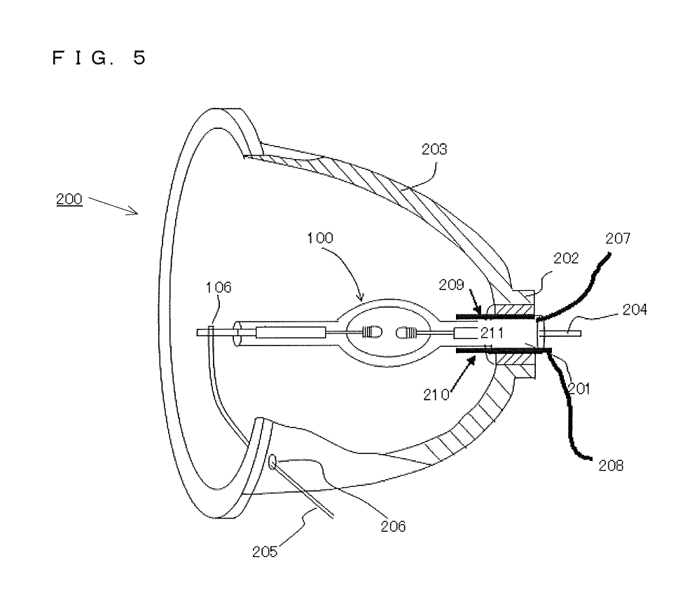

In addition, with reference to FIG. 5, it will be described that electrically conductive thin films 110 are formed on a front side and a back side of the lamp 100 and the capacitance value of the material of the lamp 100, which is sandwiched between the electrically conductive thin films 110, is monitored. In FIG. 5, a basic configuration of the lamp unit 200 is the same as that shown in FIG. 2. The detection circuit 308 monitors the capacitance (capacitance value) of a glass part 211 sandwiched between the electrically conductive thin films 209 and 210 connected to the lead wires 207 and 208, thereby monitoring the expansion of the glass, and stops the operation of the electronic ballast 300 before the lamp 100 is broken.

FIG. 4B is a table showing a relationship between the degree of expansion of the glass and the capacitance value of the glass part 211, which was obtained by experimental investigation. In the example shown in FIG. 4B, the experimental investigation made clear that when the degree of expansion of the glass reached 25%, the lamp 100 was broken. Therefore, when the capacitance value of the glass part 211 reaches 0.57 pF, the operation of the electronic ballast 300 is stopped. In other words, the detection circuit 308 has stored therein the capacitance (threshold value) of the glass part 211, which is obtained before the glass expands and the lamp 100 is broken, and when the capacitance of the glass part 211 reaches the threshold value, the detection circuit 308 sends out a signal to the control circuit 306 and stops the operation of the electronic ballast 300 (that is, terminates supply of current to the lamp 100).

In addition, when the capacitance of the glass part 211 reaches the threshold value, the detection circuit 308 may send out a signal to the control circuit 306 and decrease the current supplied from the electronic ballast 300 to the lamp unit 200. Furthermore, the detection circuit 308 may have stored therein a plurality of threshold values, and based on a relationship between the capacitance of the glass part 211 and the plurality of threshold values, the detection circuit 308 may control the electronic ballast 300 and control the current supplied to the lamp unit 200. For example, the detection circuit 308 has stored therein a first capacitance (first threshold value) and a second capacitance (second threshold value). When the capacitance of the glass part 211 reaches the first threshold value, the detection circuit 308 sends out a signal to the control circuit 306 and decreases the current supplied from the electronic ballast 300 to the lamp unit 200. When the capacitance of the glass part 211 reaches the second threshold value, the detection circuit 308 stops the operation of the electronic ballast 300.

In the above-described embodiment, the detection circuit 308 monitors the expansion of the glass (lamp 100) and stops the operation of the electronic ballast 300. After the detection circuit 308 has stopped the operation of the electronic ballast 300, the detection circuit 308 may monitor contraction of the glass (lamp 100) and resume the operation of the electronic ballast 300. For example, after the detection circuit 308 has stopped the operation of the electronic ballast 300, when the glass contracts and the degree of expansion of the glass reaches 20%, the detection circuit 308 may resume the operation of the electronic ballast 300.

(4) Projection Type Image Display Apparatus

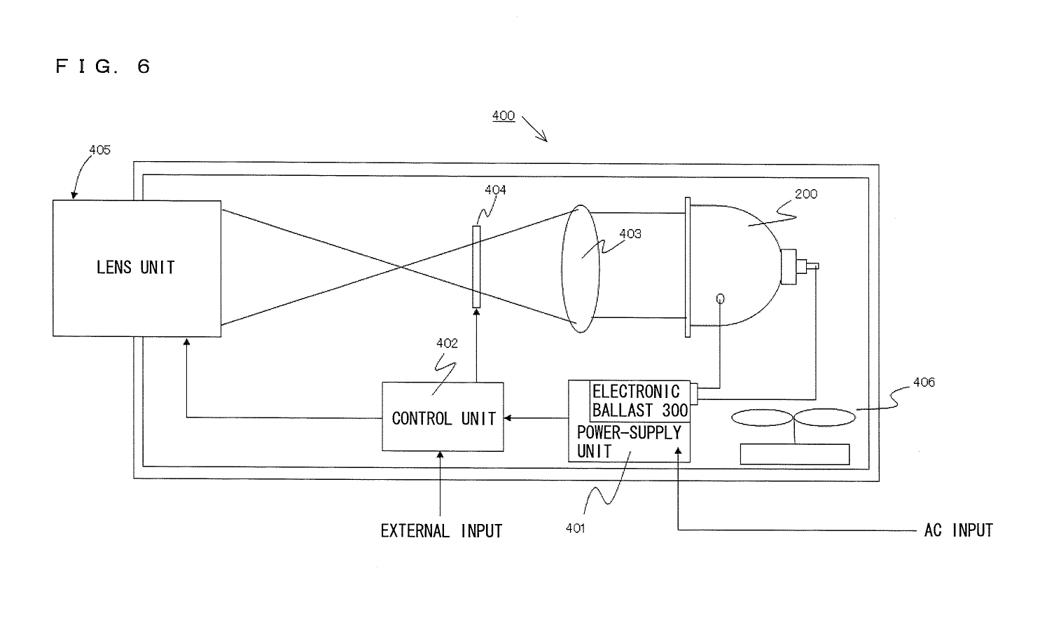

The above-described discharge lamp unit can be incorporated into a projection type image display apparatus and used. FIG. 6 is a schematic diagram illustrating a configuration of a liquid crystal projector 400 as one example of the projection type image display apparatus. As shown in FIG. 6, the transmission-type liquid crystal projector 400 includes: a power-supply unit 401; a control unit 402; a light collecting lens 403; a transmission-type color liquid crystal display plate 404; a lens unit 405 having a driving motor built-in; and a cooling fan 406.

The power-supply unit 401 converts a commercial AC input (100V) into a predetermined direct-current voltage and supplies the predetermined direct-current voltage to the control unit 402 and the electronic ballast 300. In this case, the electronic ballast 300 includes the detection circuit 308. The operations of the electronic ballast 300 and the detection circuit 308 are performed as described above. Based on an image signal externally inputted, the control unit 402 drives and causes the color liquid crystal display plate 404 to display a color image. In addition, the control unit 402 controls the driving motor inside the lens unit 405 and causes the lens unit 405 to perform a focusing operation and a zoom operation.

Light emitted from the lamp unit 200 is collected by the light collecting lens 403, passes through the color liquid crystal display plate 404 arranged in the midway of an optical path, and causes an image formed in the liquid crystal display plate 404 to be projected onto a screen (not shown) via the lens unit 405.

The lamp unit 200 according to the present invention, which includes the electronic ballast 300, is applicable to a DLP (registered trademark) type projector using a DMD (digital micromirror device), a liquid crystal projector using reflective liquid crystal elements other than the DMD, and a rear-projection type image display apparatus.

The discharge lamp unit according to the present invention is useful, for example, for preventing breakage of a lamp, which may occur while a projector or the like is being used.

While the invention has been described in detail, the foregoing description is in all aspects illustrative and not restrictive. It will be understood that numerous other modifications and variations can be devised without departing from the scope of the invention.

What is claimed is:

1. A discharge lamp unit comprising:
a discharge lamp;
a lighting device for supplying a current to the discharge lamp; and
a detection circuit for controlling, by controlling the lighting device, supply of current to the discharge lamp when the detection circuit detects expansion of the discharge lamp.

2. The discharge lamp unit according to claim 1, wherein the detection circuit detects a precursor of breakage of the discharge lamp before expansion of the discharge lamp causes breakage, controls the lighting device, and decreases the current supplied to the discharge lamp.

3. The discharge lamp unit according to claim 1, wherein the detection circuit detects a precursor of breakage of the discharge lamp before expansion of the discharge lamp causes breakage, controls the lighting device, and terminates supply of current to the discharge lamp.

4. The discharge lamp unit according to claim 1, wherein
on a surface of the discharge lamp, an electrically conductive thin film is formed, and
the detection circuit monitors at least one of the direct current resistance value of the electrically conductive thin film, the alternating current impedance value of the electrically conductive thin film, or the temperature of the electrically conductive thin film, and thereby detects the expansion of the discharge lamp.

5. The discharge lamp unit according to claim 2, wherein
on a surface of the discharge lamp, an electrically conductive thin film is formed, and
when the direct current resistance value of the electrically conductive thin film reaches a first threshold value, the detection circuit controls the lighting device and decreases the current supplied to the discharge lamp.

6. The discharge lamp unit according to claim 3, wherein
on a surface of the discharge lamp, an electrically conductive thin film is formed, and
when the direct current resistance value of the electrically conductive thin film reaches a second threshold value, the detection circuit controls the lighting device and terminates supply of current to the discharge lamp.

7. The discharge lamp unit according to claim 2, wherein
on a surface of the discharge lamp, an electrically conductive thin film is formed, and
when the alternating current impedance value of the electrically conductive thin film reaches a first threshold value, the detection circuit controls the lighting device and decreases the current supplied to the discharge lamp.

8. The discharge lamp unit according to claim 3, wherein
on a surface of the discharge lamp, an electrically conductive thin film is formed, and
when the alternating current impedance value of the electrically conductive thin film reaches a second threshold value, the detection circuit controls the lighting device and terminates supply of current to the discharge lamp.

9. The discharge lamp unit according to claim 2, wherein
on a surface of the discharge lamp, an electrically conductive thin film is formed, and
when the temperature of the electrically conductive thin film reaches a first threshold value, the detection circuit controls the lighting device and decreases the current supplied to the discharge lamp.

10. The discharge lamp unit according to claim 3, wherein
on a surface of the discharge lamp, an electrically conductive thin film is formed, and
when the temperature of the electrically conductive thin film reaches a second threshold value, the detection circuit controls the lighting device and terminates supply of current to the discharge lamp.

11. The discharge lamp unit according to claim 1, wherein on a front side and a back side of the discharge lamp, electrically conductive thin films are formed and the detection circuit monitors the capacitance value of the material of the discharge lamp, sandwiched between the electrically conductive thin films, and thereby detects the expansion of the discharge lamp.

12. A projection type image display apparatus, wherein the discharge lamp unit according to claim 1 is used.

13. A method implemented by a discharge lamp unit including a discharge lamp, the method comprising the steps of:
supplying a current to the discharge lamp;
monitoring expansion of the discharge lamp; and
controlling supply of current to the discharge lamp when the expansion of the discharge lamp is detected.
